(19) United States
(12) Patent Application Publication
(10) Pub. No.: US 2003/0062485 A1
(43) Pub. Date: Apr. 3, 2003

(54) Compact multiwavelength phase fluorometer

(76) Inventors: Salvador M. Fernandez, Hartford, CT (US); Ernest F. Guignon, Canton, CT (US); Ernest St. Louis, Hebron, CT (US)

Correspondence Address: ALIX YALE & RISTAS LLP, 750 MAIN STREET, SUITE 1400, HARTFORD, CT, 06103, US

(21) Appl. No.: 10/259,364

(22) Filed: Sep. 27, 2002

Related U.S. Application Data
(60) Provisional application No. 60/325,909, filed on Sep. 28, 2001.

(51) Int. Cl. G01N 21/64

(52) U.S. Cl. 250/458.1

(57) ABSTRACT

The present invention is a compact instrument capable of operating as a steady-state fluorimeter or as a phase fluorometer, and thus it is able to measure steady-state fluorescence intensity and fluorescence lifetime from a fluorescent sample. The light source provides four user-selectable excitation wavelengths generated by light-emitting diodes (LEDs), and has an autocalibration feature and a means to compensate for phase measurement errors due to phase-amplitude crosstalk in the detection electronics.

### CROSS REFERENCE TO RELATED APPLICATION

This application claims the priority of U.S. Provisional Application No. 60/325,909 filed Sep. 28, 2001.

### FIELD OF THE INVENTION

This invention relates to fluorescence assays and in particular to instrumentation for performing assays based on measurements of fluorescence intensity and fluorescence lifetime.

### BACKGROUND OF THE INVENTION

Certain chemical, biochemical and biological compositions, as well as living systems emit light upon exposure to illumination by light of certain wavelengths. Luminescence emission of this type includes the phenomena of fluorescence and phosphorescence. In what follows we shall refer to such compositions or systems with the term “sample” and to the molecules in the sample responsible for the fluorescence emission as fluorophores. A number of parameters are used to characterize the properties of a fluorophore. These include excitation spectrum (at what wavelengths the light is absorbed), emission spectrum (at what wavelengths the light is emitted), quantum yield (fraction of the absorbed light that is emitted as fluorescence), polarization or anisotropy (degree of polarization of the emitted fluorescence when excited with polarized light), and lifetime (a measure of the duration of the excited state). Measurement of changes in any of these parameters may be used for sensing purposes.

Fluorescence spectroscopy is a powerful method for probing biological structure and function because a fluorophore's emission and motional characteristics are exquisitely sensitive to its microenvironment. Experimentally, this sensitivity can be exploited in various ways because fluorescence detection is multidimensional in nature. Fluorescence intensity can be measured as a function of excitation or emission wavelength to obtain spectra, or it can be measured as a function of time or frequency to obtain lifetimes. Intensity can also be measured as a function of polarizer angle to obtain information about the rotational motion of the fluorophore. And these dimensional axes can be used in combination, for example with measurements of intensity versus polarizer angle and time to obtain time-resolved anisotropy decays, and hence rotational correlation times. Other advantages of fluorescence include its high sensitivity, which enables analysis of very limited quantities of material (only nanomoles of the analyte is required), and its adaptability to a variety of instrumental configurations such as microwell plates, cuvettes, microscope slides, fiber optics and many others. Measurement speed is also important, since this allows relatively high signal-to-noise data in short times amenable to high-throughput applications.

A number of methods are used to perform fluorescence measurements, each with their own advantages and limitations. First we make a distinction between macroscopic (average ensemble) and correlation methods. The former involves the measurement of integrated signals from a particular optical collection volume (normally, a significant portion of the sample well); the latter measures temporal fluctuations in the fluorescence signal detected from the diffusion of individual fluorescent molecules into and out of a small tightly focused confocal element (detection volume typically ˜1 fl). In what follows, we will not consider correlation techniques.

The most widely used fluorescence method is macroscopic steady-state spectroscopy. In this approach the sample is continuously illuminated with light of constant intensity and the measured signals are averages of all emitting fluorophores (e.g., bound and free). Lifetime-resolved methods, in contrast, allow discrimination of the emitted fluorescence not only by wavelength but also according to lifetimes of the excited states of the fluorophores. Therefore, lifetime-resolved methods enable the independent observation of different populations of a fluorophore (e.g., free or receptor-bound ligand), and thus enable the design of homogeneous assays. Lifetime-resolved methods offer additional important advantages, such as the possibility of suppressing scattering and fluorescence background signals, which enhance signal-to-noise ratio and the reliability of the analysis.

Lifetime-resolved methods can be implemented using either time-domain detection or frequency domain detection. We use the term time-domain to indicate measurement of the fluorescence decay as a function of time after pulsed excitation (typically on a nanosecond time-scale) that permits determination of the lifetimes of the emitting fluorophores. This is distinct from time-resolved methods that are used with long-lifetime fluorophores (hundreds of microseconds or greater) such as rare-earth chelates. In this case, the term time-resolved indicates that a steady-state measurement of the fluorescence intensity is performed after some delay after the excitation. This permits short-lived background luminescence to decay to a negligible level before gating on the detector to measure the fluorescence signal with an attendant improvement in signal-to-noise ratio. In frequency-domain detection the sample is excited with sinusoidally amplitude-modulated light. The fluorescence emission is then modulated at the same frequency, but because of the finite lifetime of the excited state, delayed in phase by an angle φ relative to the excitation. The phase angle, 100 of the fluorescence signal relative to the exciting light is measured and used to calculate the lifetime (τ) according to tan φ=ωτ. For fluorophores with lifetimes of the order of ˜1 ns, in the time-domain a short excitation pulse is required (˜1 ns) and in the frequency domain a high frequency is needed (˜100 MHz).

As mentioned above, the utility of fluorescence spectroscopy for sensing purposes derives from perturbation to the fluorescence process caused by changes in the local microenvironment of fluorophore molecules. Changes in the local microenvironment of fluorophore molecules are usually manifested through their impact on the radiative and nonradiative decay rates respectively. The quantum efficiency of the fluorescence depends on both the radiative and nonradiative decay rates and so, in principle, it may be used to provide functional information. However, determination of the quantum efficiency from intensity measurements requires knowledge of the absolute intensities of the absorbed and emitted light and the fluorophore concentration; information that is difficult to obtain. Quantum efficiency can also be obtained from the fluorescence lifetime, which also depends on the radiative and nonradiative decay rates but which may be determined from relative measurements with no knowledge of the fluorophore concentration. Therefore, lifetime is inherently robust against the limitations of intensity-based methods and is a more reliable and useful probe of fluorophore environment (and hence function). This is the fundamental advantage of lifetime over intensity-based methods.

Lifetime methods are also robust against other potential problems that can affect intensity-based methods, such as photobleaching of the fluorophore, light source fluctuations, optical misalignments, drift in the detector electronics, and turbidity or the presence of optically absorbing compounds in the sample.

As a result of the benefits provided by lifetime-based fluorescence sensing there is considerable interest in compact, low-cost instrumentation for performing multidimensional fluorescence measurements that include fluorescence lifetime. Potential applications include in vivo clinical diagnostics, where small size and low power requirements are specially important because the device may be worn by the patient; in situ environmental monitoring where a low-weight, portable, battery-operated instrument is needed; real-time, on-line industrial process analysis where a rugged, compact, low-cost package with a fiber-optic sample interface and rapid data acquisition capability is required; space based applications where power usage, size and weight are of paramount concern, and in situ oceanographic sensing where long-term deployment of a sensor at a mooring may be necessary.

### SUMMARY OF THE INVENTION

The present invention represents an improvement over the invention described in U.S. Pat. No. 5,818,582, the entire contents of which are hereby incorporated by reference. One embodiment of the invention is a compact, single-frequency phase fluorometer with heterodyne detection able to provide modulated excitation at multiple user-selectable wavelengths and with the capability of measuring steady-state fluorescence intensity, fluorescence lifetimes by phase delay and amplitude demodulation, static fluorescence polarization and differential polarized phase fluorescence.

In frequency domain mode, the operation of the fluorometer apparatus is as follows: A low-frequency baseband signal is generated by a first signal generating means. The output of the baseband signal generating means is split into two signals one of which we refer to as the “reference” signal, and the other as the “sample” signal. The reference signal provides the reference for the phase determination of the sample signal. The sample signal is used to generate the modulated light which probes the sample in order to acquire the phase and amplitude information corresponding to the fluorescence emitted by any fluorophores in the sample. However, the low frequency fₒ of the baseband sample signal is inadequate to generate a significant phase shift and relative demodulation in the fluorescence from most fluorophores of practical interest, which have average lifetimes in the range of hundreds of picoseconds to tens of nanoseconds. In the present invention, therefore, the baseband sample signal fₒ is up-converted to a modulation frequency f+fₒ by combining the baseband sample signal with a carrier signal at frequency f, by means of a frequency up-converter. The carrier signal, f, is generated by a second frequency generating means, and the value of f is chosen to produce a significant phase shift in the emitted fluorescence due to the finite luminescence lifetimes of the emitting fluorophores in the sample, for example 100 MHz.

The up-converted sample signal at frequency f+fₒ is used to modulate the light source. The optical fluorescence signal at the up-converted frequency f+fₒ resulting from the interaction of the modulated light with the sample, and containing the phase and depth of modulation information of analytical interest is converted to an electrical signal of frequency f+fₒ by a photodetecting means. The electrical output signal of said photodetecting means is then mixed with the carrier signal f in an RF mixer to down-convert it to the baseband frequency in order to recover the sample signal at frequency fₒ, now containing the phase and amplitude of analytical interest. The sample signal acquires a fixed time delay due to optical and electronic propagation through the instrument and contains the phase and amplitude information from the sample. In contrast, the reference signal acquires only a fixed time delay due to electronic propagation through the instrument. The fixed instrument-related delays are calibrated out by using a non-fluorescent scattering sample (zero lifetime calibrating sample), or a reference sample of known fluorescence lifetime.

In steady-state intensity mode light source is modulated at the baseband frequency, without any upconversion and the detector is used in a lock-in mode. Since fluorescence lifetimes of interest are of the order of 10⁻⁹ s, at this low modulation frequency, the amplitude of the signal is not affected by the fluorescence lifetime, and it is thus directly proportional to steady-state fluorescence intensity.

In the frequency-domain mode of operation, changes in the intensity of the fluorescence signal incident on a photomultiplier tube (PMT) detector may cause changes in the measured phase of the signal. This problem, generally referred to as “phase-amplitude crosstalk”, is caused by the phase response characteristics of the detector and the associated RF detection electronics. The present invention includes an electronic means, dynode feedback, to compensate for phase-amplitude crosstalk.

The principle of dynode feedback is that in a PMT the electron transit time is reproducible and decreases as the accelerating voltage between dynodes increases. Changes in electron transit time lead to changes in the phase of the signal. This phenomenon provides a basis for compensating for phase-amplitude crosstalk. In the present invention the amplitude of the PMT AC output is used to control the dynode high voltage in a feedback loop to keep the PMT AC output amplitude constant. This dynode feedback can be thought of as an automatic gain control (AGC) loop. Since the phase-voltage characteristics of the PMT are deterministic, any phase error introduced by the change in PMT dynode voltage can be compensated in software.

The present invention also provides means for internal phase self-calibration. As described above, the measured phase angle φ is used to calculate the lifetime (τ) according to tan φ=ωτ where φ is the phase angle difference between the fluorescence and excitation signal. Since the propagation of optical and electrical signals through the instrument introduce a fixed but unknown phase delay, it is necessary to calibrate the system to determine the phase value corresponding to the excitation signal. In practice this is done by measuring the phase delay, φₒ, corresponding to a zero-lifetime calibrating sample (typically a non-fluorescent scattering solution). Then, if the phase of the fluorescence signal is φ_{f}, the lifetime is calculated from tan(φ_{f}−φₒ)=ωτ.

If the instrument calibration were stable, then calibration would only have to be performed once. Unfortunately, the phase characteristics of some of the electronic and optoelectronic components in the frequency-domain detection system may drift over time with ambient temperature changes. Therefore, to obtain accurate results frequent calibration may be required. This problem becomes particularly important in a field instrument where the system may be exposed to a range of ambient temperatures during operation or in an on-line continuously monitoring system where it would be cumbersome to insert a calibrating sample into the instrument.

To overcome this problem the present invention includes an internal calibration channel comprising a fiber-optic optical delay line. The input end of this optical fiber picks off a small fraction of the excitation light and its output is coupled to the detector. A calibration channel shutter prevents excitation light traveling through the fiber-optic channel from reaching the detector during fluorescence measurement. Conversely, the shutter prevents fluorescence signal from the sample from reaching the detector during auto-calibration. A measurement through the calibration channel will produce a phase delay having a fixed component attributable to light propagation through the fiber optic delay line and a variable component attributable to propagation of signals through the electronic components of the fluorometer. Change in the time required for the propagation of signals through the electronic components of the fluorometer is referred to as drift. In contrast, a measurement of a fluorescence sample in the sample channel will have three components: a fixed component of optical delay; a variable component of drift; and an unknown component of delay attributable to the fluorescence lifetime of the sample. The calibration channel eliminates the sample fluorescence to isolate the drift component.

When the fluorometer is used to monitor changes in the phase delay of sample fluorescence over time, measurements through the calibration channel are used to account for drift. For example, a first set of phase measurements are made at time t=0 and a second set of measurements are made at time t=0+x. The calibration channel phase measurement at t=0 is compared to the calibration channel phase measurement at time t=0+x with the difference being attributable to drift in the instrument components over time period x. The sample channel measurement at time t=0+x is corrected to account for the drift, resulting in an accurate measurement of the relative change in the phase delay of the sample fluorescence over time period x.

The calibration channel may also be calibrated with respect to a scattering (zero fluorescence lifetime) sample in the sample channel. The relationship of the calibration channel to a zero fluorescence lifetime sample in the sample channel is assumed to remain constant over time. This known relationship, in addition to the function of the calibration channel in tracking drift, allow correction of a measured phase delay of sample fluorescence to produce an accurate absolute value of fluorescence lifetime. In other words, the measured phase delay is corrected for drift and to account for the relationship of the calibration channel to a zero fluorescence lifetime.

Another feature of the present invention is a means to provide user-selectable excitation at multiple different wavelength bands. Wavelength selection is accomplished through the use of multiple amplitude-modulated light sources and an optical switch.

The sample compartment holds a sample so that detection of the emitted fluorescence is at 90 degrees from the incident excitation light. Provisions are also included for excitation and detection through a bifurcated fiber optic interface. Detection is performed with a photomultiplier tube (PMT) or photodiode in a conventional 90° geometry relative to the excitation optical axis. A means for optical filtering in front of the PMT permits selection of different detection passbands.

An object of the invention is to provide a new and improved fluorometer of compact and efficient design.

Another object of the present invention is to provide a new and improved fluorometer with improved accuracy.

These and other objects, features and advantages of the present invention will become readily apparent to those of skill in the art upon reading the detailed description of the preferred embodiments, in conjunction with the accompanying drawings.

### BRIEF DESCRIPTION OF THE DRAWINGS

FIG. 1 is a block diagram illustrating the major functional units of one embodiment of a fluorometer exemplary of several aspects of the present invention;

FIG. 2 is a block diagram illustrating details of interaction of a Digital Signal Processor portion of the System Controller with portions of the Transmitter Module and Receiver Module of the fluorometer of FIG. 1;

FIG. 3 is a functional schematic diagram of an exemplary internal phase reference channel for use in conjunction with a fluorometer;

FIG. 4 is a perspective view of one embodiment of multiple excitation light sources in conjunction with an optical switch exemplary of several aspects of the present invention; and

FIG. 5 is a functional schematic diagram of an exemplary feedback circuit to compensate for phase-amplitude crosstalk for use in conjunction with a fluorometer.

### DETAILED DESCRIPTION OF THE PREFERRED EMBODIMENTS

With reference to FIG. 4, a preferred embodiment of the present invention incorporates four modulated light-emitting diodes 61 as a light source to provide excitation in at least four different excitation bands. A software-controlled optical switch 60 permits selection of one LED at a time for sample illumination. A bandpass filter 62 in front of each LED 61 provides the means for further tuning of the excitation band within the spectral width of the LED emission.

One specific example of this embodiment uses four excitation bands centered at 385 nm, 436 nm, 490 nm and 525 nm. The LEDs 61 used are from Nichia America (Mountville, Pa.). The bandpass filters 62 are from Chroma Technology (Brattleboro, Vt.). This particular choice of excitation wavelengths was used to enable specific applications. For example 380 nm is well suited for exciting blue fluorescence protein (BFP) in FRET (fluorescence resonance energy transfer) assays. Likewise, 440 nm is ideal for exciting cyan fluorescence protein (CFP) in FRET assays. The 490 nm wavelength serves to excite green fluorescence protein (GFP), and also all widely used fluorescein derivatives. Finally, 525 nm is well suited for exciting many useful biological fluorophores, such as Calcium green, rhodamine derivatives and Cy3. Any LED that can be modulated with reasonable depth of modulation in the range of 10 to 100 MHz may be used in the present invention.

In this embodiment excitation wavelength is selected by means of the LED selector wheel 67. This wheel 67 has a rhomboid prism 68 mounted on it, one end of which is aligned over an opening on the wheel containing an imaging lens 66, and the other end of which is centered on the axis of rotation A of the wheel. By rotating the wheel, the opening can be aligned with the optical axis B of any one of the four LEDs 61. The prism 68 includes two parallel reflecting surfaces 68a and 68b which offset light from the optical axis B of a selected LED 61 to a path substantially coincident with the rotation axis A of the selector wheel 67. A stepping motor 69 under computer control drives the selector wheel 67. This arrangement permits on-the-fly selection of up to four different excitation wavelengths without making any hardware changes to the instrument.

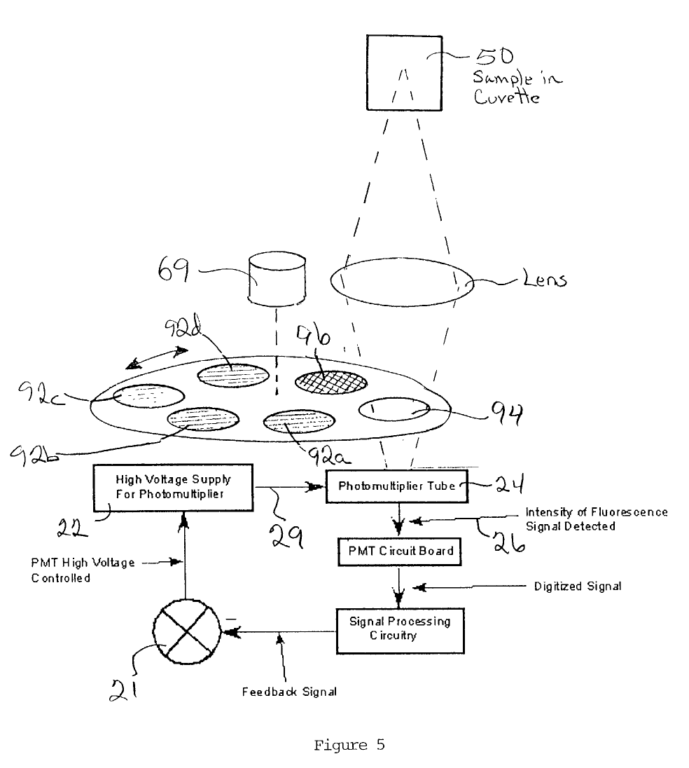

With reference to FIG. 5, selection of the detector bandpass may be accomplished with a filter wheel 90 placed in front of the photomultiplier tube 24. The detector filter wheel 90, also driven by a stepping motor 69, holds four sets of emission bandpass filters 92a-92d. In addition, it contains one open window 94 and a closed shutter 96. In one example of this embodiment we used detection bandpass filters centered at 450, 480, 535 and 575 nm. Other bandpass filters may be used depending on the emission characteristics of the fluorophores of interest. The detector is a Hamamatsu R6357 side-on photomultiplier tube.

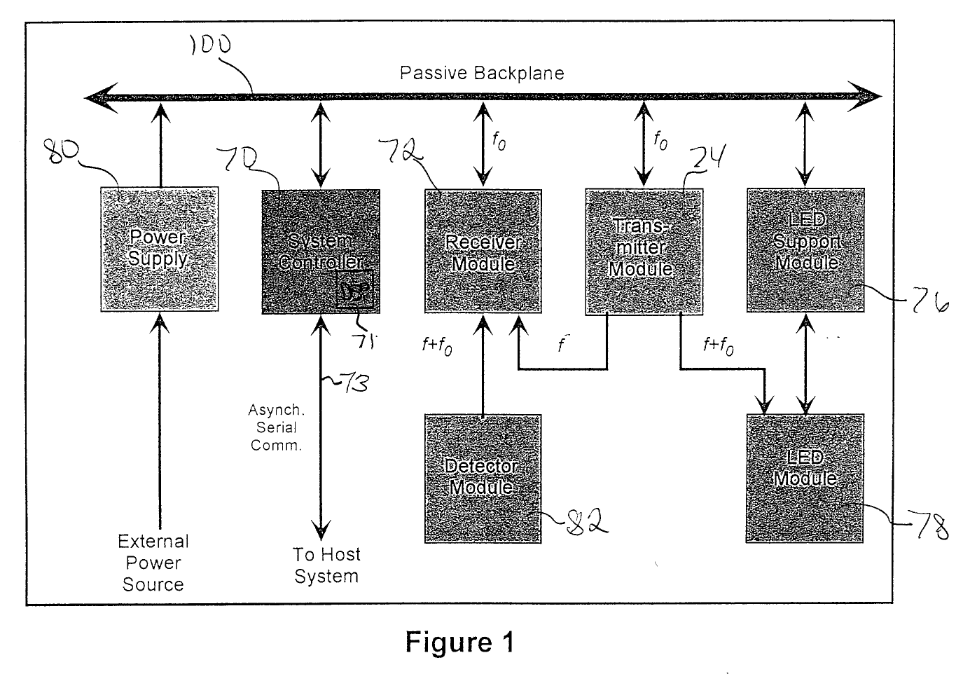

In this embodiment most of the electronics modules reside on a passive backplane 100, which provides inter-module communication and power to the various modules. All communication between the modules are digital. Baseband (fₒ) signals are present on the backplane 100, but these are in the form of digitized waveforms. There are no analog signals on the backplane 100. Connection of the resident modules to the backplane is by high reliability, pin and socket connectors (DIN 41612). The non-resident modules also rely on the backplane for their power and communications. Power and signals are routed from the backplane through the Receiver Module 72 and Transmitter Module 74, to the Detector Module 20 and LED Module 78. A system schematic is shown in FIG. 1. A brief description of each of the electronics modules shown in FIG. 1 is as follows.

The System Controller 70 performs all data acquisition and computational tasks necessary to calculate the fluorescence lifetime. It also performs various monitoring and alarm tasks. The System Controller 70 receives commands from and uploads data to a host laptop computer via a communication link. The System Controller 70 is based on a single board computer (SBC) which is in turn based on an 8-bit microcontroller (MC68HC11). Communication with the host is via an asynchronous serial communication link 73 with an RS-232 interface. EEPROM is used for program storage. The SBC also contains a digital signal processor IC (DSP) 71. The DSP 71 is slaved to the microcontroller and offloads most of the computational burden from the microcontroller.

The Transmitter Module 74 generates the carrier frequency f and upconverts the baseband signal f₀. The resultant signal (f+f₀) is supplied to the LED Module 78. The System Controller 70 sets the output amplitude of this signal. The carrier frequency f is also provided to the Receiver Module 72 for use in down conversion. The Transmitter Module 74 contains a high-stability crystal oscillator for the carrier frequency. It also contains circuitry to perform the upconversion. The baseband signals f₀ come to the module in digital form so there are digital-to-analog converters (DACs) and reconstruction filters on board.

The LED Support Module 76 and LED Module 78 are mounted in the Optics Module of the fluorometer. They provide mechanical support for the LEDs 61 as well as circuitry to drive them. In addition to the modulating signal (f+f₀), it is also necessary to provide the LEDs with a DC current because the modulating signal is a sinusoid with positive and negative halves. The LED only conducts current in one direction. Therefore, to keep the LED turned on, the LED drive signal consists of a DC pedestal or “bias” current with the modulating signal riding on it. The LED Module 76 contains the circuitry necessary to provide a stable, DC current through the LEDs 61. The LED Module 78 also contains a transconductance amplifier to impress the modulating RF signal on the LED bias current. An RF switch (not shown) is used to power the selected LED.

The Detector Module 82 converts the PMT (detector) output (fluorescence signal) to an electrical signal and amplifies it before sending it to the Receiver Module. The PMT (detector) output is a small electrical current. A high-speed current-to-voltage converter and an amplifier are used to condition this signal. The PMT also requires a high voltage, low current supply, therefore the module also contains a high voltage DC/DC converter.

The Receiver Module 72 converts the high-frequency component of the detected fluorescence signal to something the DSP can handle. It does this by performing downconversion, amplification, filtering and A/D conversion on the high-frequency signal to produce a version of the original baseband signal f₀, which contains the desired phase shift information.

The Power Supply Module 80 converts the 120 VAC wall power to the voltages necessary to run the circuitry. There are several voltages required. They are +12 VDC required by some of the RF circuitry and stepper motors, +5 V for the digital circuitry, and ±5 for the analog circuitry. The Power supply module 80 also provides line conditioning such as over current protection, noise filtering and surge arresting.

The firmware necessary to operate the instrument is divided between the System Controller 70 and the Digital Signal Processor 71. The System Controller firmware, which has been programmed in FORTH language, has a significant number of tasks to perform that fall into several distinct categories.

The first category is numerical calculations. The primary calculation is the fluorescence lifetime. This calculation is based on data provided by the DSP 71. The second category is communication. Referring to FIG. 1, the System Controller is equipped to communicate with a host computer over a serial channel 73. The System Controller 70 has a command interpreter built in which receives its commands from this serial channel. The command interpreter can execute any portion of the System Controller's program interactively.

Control functions constitute the next category. The System Controller 70 is responsible for setting the LED bias current and modulation amplitude. It also performs selection of the carrier frequency f for frequency-domain or amplitude measurements and sets the gain of the variable gain amplifier on the Receiver Module 72.

The last category is miscellaneous functions. The DSP 71 has only volatile memory for program storage on board. Therefore, on power up, the System Controller 70 downloads the DSP program from its own non-volatile memory. This imposes no hardship on the System Controller 70 as the DSP program size is purposefully kept to a minimum.

In contrast to the System Controller 70, the DSP 71 has only three tasks to perform. They are generation of the baseband signal f₀, acquisition of returned baseband signal and calculation of a single frequency Discrete Fourier Transform (DFT) on the acquired data. Before any of this happens, the System Controller 70 will have provided the DSP 71 with values for the number of samples in each data set, the sample rate and the phase increment which determines the frequency of the baseband signal and the number of sample points in each cycle of the waveform. The DSP 71, in turn, will have initialized the phase variable to zero. Upon receiving a start command from the System Controller 70, the DSP 71 begins acquiring and processing a data set corresponding to a single lifetime measurement. The DSP functions are programmed in Assembly language.

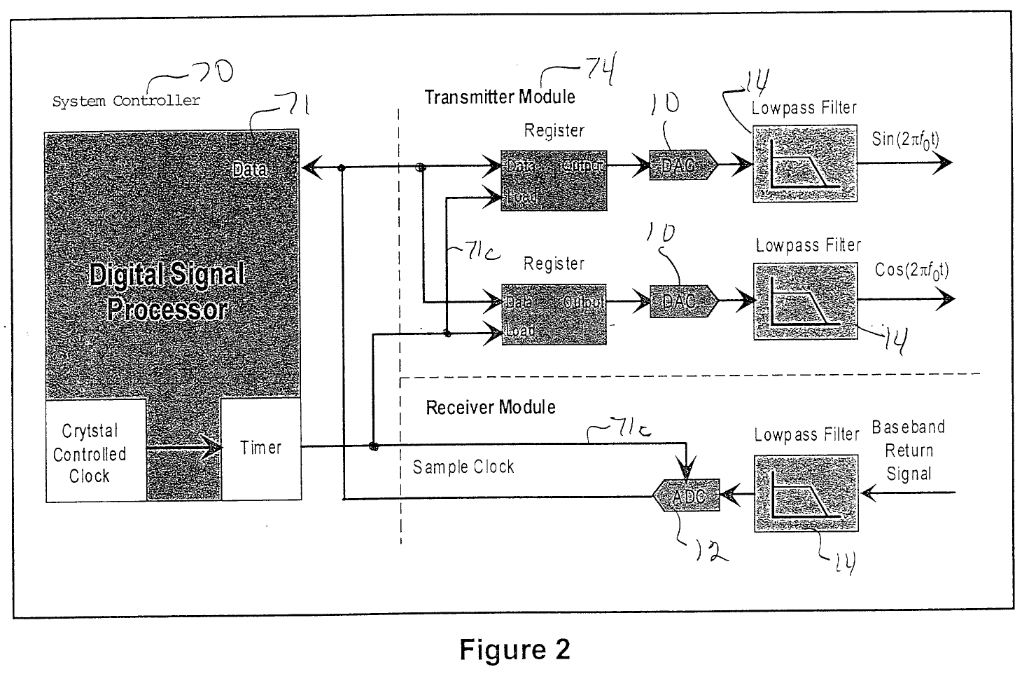

The baseband signal f₀ must be supplied to the single sideband modulation circuitry as a quadrature pair. Therefore, for each sample time, the DSP calculates and outputs the values of sine and cosine for the current value of the phase variable. The calculation is done via a combination of lookup table and interpolation. Referring to FIG. 2 it will be seen that these two values are stored in registers (not illustrated) before being applied to their respective DACs 10 and reconstruction lowpass filters 14. The two values are calculated sequentially, but it is necessary to update the two DACs 10 simultaneously to preserve the quadrature phase relationship, hence the registers. Again referring to FIG. 2, it will be noted that the timing signal 71c that updates the DACs 10 is also the sample clock for the analog-to-digital converter (ADC) 12. The digitized downconverted return signal is then multiplied by the sine and cosine values just calculated and the two products are accumulated separately. The phase increment is then added to the phase variable. This process is repeated for the number of points in a data set. The two accumulated values are essentially the complex DFT coefficients of the return signal at the baseband frequency (ignoring a scale factor for the moment). At the end of the acquisition of the data set, these values are scaled and returned to the System Controller 70. The phase variable is reinitialized to zero for the next data set and a “data ready” signal is sent to the System Controller 70. The first few cycles of each data set are affected by the startup transients of the various low pass filters in the system and therefore are ignored.

There are a number of benefits to be derived from this dual processor architecture. It allows almost continuous measurement. While the microcontroller calculates the lifetime, the DSP 71 acquires the next sample block and calculates its DFT. The complex coefficients are available almost immediately after the last data point is taken because the DFT is calculated concurrently with the data acquisition. The maximum rate at which individual lifetime measurements can be made is essentially determined by either the time to acquire a data set or the time needed to calculate the lifetime from the DFT data, whichever is longer. Increasing the data acquisition time increases the noise rejection of the measurement. Measurement rates of the order of a few Hz or greater should be readily achievable. This will be valuable for measuring transient cell responses with high resolution.

Other benefits include the following: The DFT is always calculated at precisely the right frequency even if the DSP clock drifts. As the baseband signal is generated in software, its frequency is programmable. No electronic phase reference signal is needed, reducing hardware and software complexity. Both microcontroller and DSP are designed for low power operation. Each has a low power “dormant” mode. A design based on a single general-purpose microprocessor with this much computational and interface capacity would generally not have this capability.

FIG. 5 illustrates the dynode feedback circuit 21 for controlling the output amplitude of the photomultiplier tube 24. Phase-amplitude crosstalk correction by dynode feedback in accordance with an aspect of the invention is implemented as follows: A DAC (digital-to-analog) channel on the PMT HV supply board 22 controls the PMT bias voltage 29. As the DAC output varies from 0 to 5V, the HV on the PMT changes from 625 to 1250 V. A search algorithm in software finds the appropriate HV 29 necessary to bring the PMT output 26 to the desired set point. Thus, if the incident radiant flux on the PMT is high and the detected signal level exceeds the set point, then the search algorithm lowers the output of the PMT by lowering the HV 29 from its normal operating point of 1100 volts. From the known phase vs. HV response of the PMT (stored in a look up table or in a functional relationship), a software algorithm calculates the phase shift introduced by the high voltage adjustment and uses this value to correct the measured phase.

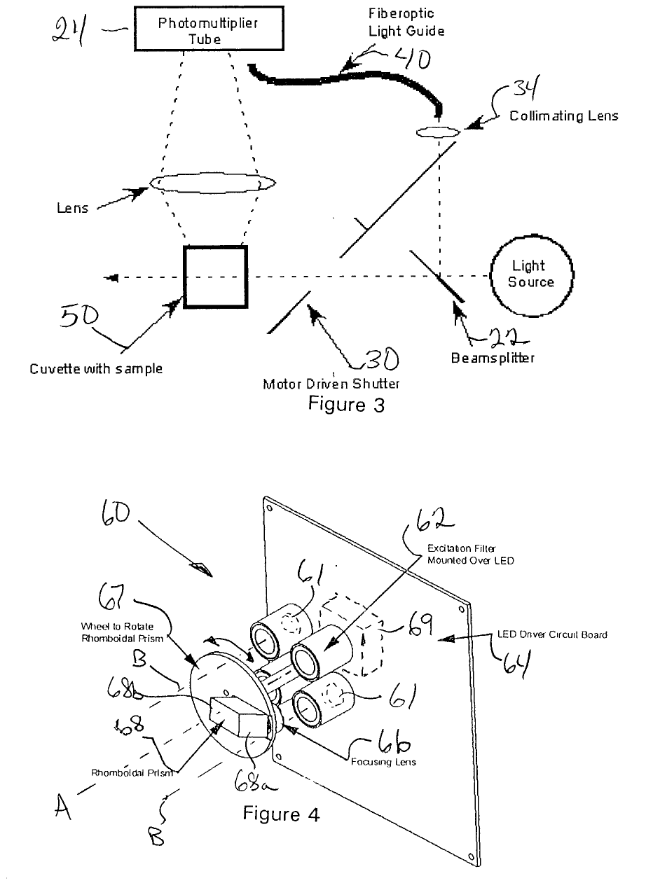

The auto calibration feature of the present invention is best discussed with reference to FIG. 3. A signal path corresponding to measurement of fluorescence of a sample in the cuvette received by the photomultiplier tube and propagating through the fluorometer circuitry is referred to as the “sample channel”. An aspect of the invention relates to provision of a parallel “calibration channel” which eliminates the unknown quantity of phase delay attributable to the fluorescence lifetime of the sample to isolate, and therefore permit correction for, the variable of drift. The calibration channel comprises means for diverting a portion of the excitation light into a fiber optic delay channel coupled to the fluorescence detector. The time (phase delay) required for light to traverse the fiber optic delay channel is a known, fixed value. Therefore, changes in the phase delay in excitation light diverted through the calibration channel are due to changes in the time required for optical and electronic signals to propagate through the fluorometer components. As previously discussed, characteristics of the fluorometer components affecting signal propagation change over time and with ambient temperature. These changes cause changes in the time required for signals to propagate through the fluorometer components, otherwise known as drift. Drift is monitored by measurements through the calibration channel.

Auto calibration is implemented as follows: A beam splitter 22 diverts a portion of the excitation light through a collimating lens 34 and into the fiber optic light guide 40. An output end of the light guide 40 is coupled to the photomultiplier tube 24. A shutter 30 alternatively presents light from the sample in the cuvette holder 50 or the fiber optic light guide 40 to the photomultiplier tube 24. A phase delay measurement through the calibration channel includes the fixed delay due to the propagation of light through the optical fiber plus any delay due to propagation of optical and electrical signals through the instrument (including drift). Comparisons of calibration channel measurements over time allow the fluorometer to account for drift. Sample channel measurements compensated for drift provide accurate measurements of relative changes in the fluorescence lifetime of a sample.

The calibration channel may also be calibrated relative to a scattering (zero fluorescence lifetime) sample in the cuvette. The scattering sample eliminates the unknown of the sample fluorescence lifetime to establish the relationship of a calibration channel phase measurement to a sample channel measurement having a zero fluorescence lifetime. This differential between the sample channel with a scattering sample and the calibration channel is attributable to the alternative optical portions of the signal path, the electronic portions of the signal path being identical. Since signal propagation through the optical portions of the sample and calibration channels is assumed to be very stable, the differential should remain constant over time. Once known, this differential is used to correct sample channel phase delay measurements to an absolute value of fluorescence lifetime. The calibration channel provides a stable reference corresponding to a zero fluorescence lifetime sample, thereby eliminating the need to introduce a scattering sample into the sample channel for calibration purposes.

In cases where the fluorophore exhibits a large Stokes shift, another phase error may be introduced due to color effects in the PMT detector. This occurs when the time response of the PMT at the excitation wavelength is different than that at the emission wavelength. In such cases the reference channel may be calibrated against a standard fluorophore of known fluorescence lifetime, rather than against a non-fluorescent scattering solution.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed:

1. An apparatus for changing the frequency of excitation light incident upon a sample, said apparatus comprising:
a plurality of excitation light sources, each said excitation light source having an optical axis and emitting a different frequency of excitation light when energized, said plurality of excitation light sources being radially equidistant from an axis;
two parallel reflecting surfaces rotatable about said axis to redirect excitation light from the optical axis of a selected one of said excitation light sources along said axis,
whereby the excitation light from the selected excitation light source is incident upon said sample.

2. The apparatus of claim 1, wherein said two parallel reflecting surfaces are surfaces of a rhomboidal prism.

3. The apparatus of claim 1, wherein said two parallel reflecting surfaces are surfaces of a rhomboidal prism, said rhomboidal prism being mounted to a wheel centered on and rotatable about said axis.

4. The apparatus of claim 3, wherein said wheel is driven by a stepping motor under computer control.

5. The apparatus of claim 1, comprising an optical bandpass filter mounted between at least one excitation light source and said parallel reflecting surfaces, wherein said filter restricts the frequency of excitation light emitted from the at least one excitation light source to a portion of a spectrum of excitation light emitted by the at least one excitation light source.

6. The apparatus of claim 1, comprising optics for focusing excitation light emitted from the selected one of said excitation light sources onto said sample.

7. The apparatus of claim 1, wherein said excitation light sources are LEDs.

8. A method for selecting the frequency of excitation light incident upon a fluorometer sample comprising:
arranging a plurality of excitation light sources at a fixed radial distance from a central axis, each of said excitation light sources producing a different frequency of excitation light along an optical axis;
rotating first and second reflecting surfaces around said central axis, said first reflecting surface being intersected by said central axis and said second reflecting surface being in fixed parallel relationship to said first reflecting surface, said second reflecting surface traversing an arc that intersects each of the optical axes of the plurality of excitation light sources; and
stopping said rotation with said second reflecting surface substantially centered on the optical axis of a selected one of said plurality of excitation light sources, whereby light is offset from the optical axis of a selected one of said excitation light sources to a path along said central axis and incident upon said sample.

9. The method of claim 8, wherein said step of rotating comprises:
energizing a stepping motor connected to said first and second reflecting surfaces.

10. The method of claim 9, wherein said step of energizing comprises:
initiating said energizing by means of computer control.

11. A method for reducing phase-amplitude crosstalk in a phase fluorometer comprising a photomultiplier tube which produces an output whose amplitude varies with the intensity of detected fluorescence, said amplitude also varying according to the level of high voltage applied to a dynode of the photomultiplier tube:
applying the amplitude to a feedback circuit to vary the high voltage applied to the dynode of the photomultiplier tube,
whereby the output amplitude is maintained at a selected set point.

12. The method of claim 11, wherein said maintaining comprises:
using a search algorithm in software to determine the level of high voltage that, when applied to the dynode of the photomultiplier tube will bring the output to the set point.

13. The method of claim 11, comprising:
calculating a phase shift introduced into the detected fluorescence by the variation of the high voltage applied to the dynode; and
using the calculated phase shift to correct the phase of the detected fluorescence.

14. An apparatus for self calibration in a fluorometer comprising:
a fiber optic reference channel having an input end arranged to receive a portion of excitation light produced by an excitation light source and an output end coupled to a fluorescence detector, said reference channel having a known optical delay; and
a calibration channel shutter arranged to prevent excitation light from traversing the reference channel during fluorescence measurement and to prevent a fluorescence produced by a sample exposed to the excitation light from reaching the detector during calibration,
wherein excitation light traversing the calibration channel has a phase delay including the known optical delay of the reference channel and a variable delay due to propagation of optical and electrical signals through the fluorometer, the phase delay of excitation light through the calibration channel being compared to a previous value of phase delay through the excitation channel to determine a calculated time drift attributable to changes in the propagation of optical and electrical signals through the fluorometer.

15. A method for continuously calibrating a fluorometer comprising:
diverting a portion of excitation light directed at a sample into a calibration channel having an output coupled to a fluorescence detector;
activating a shutter to prevent fluorescence from the sample from reaching the detector, said shutter permitting excitation light traversing the calibration channel to reach the detector;
measuring a second phase delay between the signal used to modulate a source of the excitation light and an output of the detector;
comparing the measured second phase delay to a previous first phase delay measurement through the calibration channel to determine a drift in the propagation of optical and electrical signals through the fluorometer;
activating the shutter to permit fluorescence from the sample to reach the detector, said shutter preventing excitation light from reaching the detector through the calibration channel;
measuring the phase delay between the fluorescence from the sample and the signal used to modulate a source of the excitation light and an output of the detector; and
using the drift to calculate a corrected phase delay of the fluorescence measured from the sample.

16. The method of claim 15 comprising:
placing a reference sample of known fluorescence lifetime in the fluorometer;
activating the shutter to permit fluorescence from the sample to reach the detector, said shutter preventing excitation light from reaching the detector through the calibration channel;
measuring the phase delay of an optical signal produced by the reference sample;
calculating a differential between the phase delay of the reference sample and a phase delay measurement through the calibration channel contemporaneous to the activating and measuring steps producing the optical signal; and
using the differential to calculate the fluorescence lifetime of samples subsequently placed in the fluorometer.
